(19) United States
(12) Patent Application Publication
(10) Pub. No.: US 2023/0360153 A1
(43) Pub. Date: Nov. 9, 2023

(54) SELL PREDICTION DEVICE, SELL PREDICTION METHOD, AND RECORDING MEDIUM

(71) Applicant: NEC Corporation, Minatu-ku,, Tokyo (JP)

(72) Inventors: Satoshi SAKAKIBARA, Tokyo (JP); Yusuke Iwasaki, Tokyo (JP); Akio Kawachi, Tokyo (JP); Yuya Hanzawa, Tokyo (JP); Xiaoyu Song, Tokyo (JP)

(73) Assignee: NEC Corporation, Minatu-ku,, Tokyo (JP)

(21) Appl. No.: 18/026,499

(22) PCT Filed: Sep. 23, 2020
(86) PCT No.: PCT/JP2020/035670

§ 371 Date: Mar. 15, 2023

(51) Int. Cl. G06Q 50/16; G06Q 30/0202; G06Q 30/0201; G06Q 30/02

(52) U.S. Cl. CPC G06Q 50/16; G06Q 30/0202; G06Q 30/0206; G06Q 30/0278

(57) ABSTRACT

The sell prediction device according to the present invention comprises: a sell prediction unit that predicts customers with potential to sell a house, on the basis of a prediction model that predicts customers with potential to sell a house and that is generated based on house/customer data, sell record data, and property appraisal data, and on the basis of a target customer's house/customer data and property appraisal data; and an output unit that outputs predicted customers.

### TECHNICAL FIELD

The present disclosure relates to a sell prediction device or the like that predicts customers who are likely to sell a house.

### BACKGROUND ART

If a sales representative of a housing manufacturer finds out customers who are likely to sell a house, the sales representative can create an opportunity to come in contact with the new or existing customers and implement various measures to promote the sale. However, the timing of selling a house is different depending on each customer.

As a system for supporting business activities, PTL 1 discloses an information processing device that predicts a real estate transaction contract probability for reference of determination of a real estate market price or adjustment of a contract price.

### CITATION LIST

### Patent Literature

[PTL 1] JP 2017-16321 A

[PTL 2] US 2014/0222741 A

### SUMMARY OF INVENTION

### Technical Problem

However, the technology disclosed in PTL 1 predicts the contract probability of real estate transaction for a customer who indicates intention of sale, and does not predict a customer who may sell their house. One object of the present disclosure is to provide a sell prediction device or the like that predicts customers who are likely to sell a house.

### Solution to Problem

A sell prediction device of a first aspect of the present disclosure includes
a sell prediction means configured to predict customers who are likely to sell a house in accordance with a prediction model that is generated based on house/customer data, sell record data, and property appraisal data and predicts customers who are likely to sell a house, and the house/customer data and property appraisal data of target customers, and
an output means configured to output the predicted customers.

A sell prediction method according to a second aspect of the present disclosure includes
predicting customers who are likely to sell a house in accordance with a prediction model that is generated based on house/customer data, sell record data, and property appraisal data and predicts customers who are likely to sell a house, and the house/customer data and property appraisal data of target customers, and outputting the predicted customers.

A sell prediction program according to a third aspect of the present disclosure is a program that causes a computer to execute processing including
predicting customers who are likely to sell a house in accordance with a prediction model that is generated based on house/customer data, sell record data, and property appraisal data and predicts customers who are likely to sell a house, and the house/customer data and property appraisal data of target customers, and outputting the predicted customers.

The sell prediction program may be stored in a non-transitory computer-readable/writable recording medium.

### Advantageous Effects of Invention

According to the present disclosure, there is provided a sell prediction device or the like that predicts customers who are likely to sell a house.

### BRIEF DESCRIPTION OF DRAWINGS

FIG. 1 is a block diagram illustrating an example of a configuration of a sell prediction device and a database according to a first example embodiment.

FIG. 2 is a diagram illustrating an example of a data structure of house/customer data.

FIG. 3 is a diagram illustrating an example of a data structure of sell record data.

FIG. 4 is a diagram illustrating an example of a data structure of property appraisal data.

FIG. 5 is a diagram illustrating an example of a prediction model.

FIG. 6 is a diagram illustrating an example of a prediction model, conditional branching, and degrees of impacts.

FIG. 7 is a flowchart illustrating an example of operation of the sell prediction device according to the first example embodiment.

FIG. 8 is a block diagram illustrating an example of a configuration of a sell prediction device according to a second example embodiment.

FIG. 9 is a flowchart illustrating an example of operation of the sell prediction device according to the second example embodiment.

FIG. 10 is a block diagram illustrating an example of a hardware configuration of a computer.

### EXAMPLE EMBODIMENTS

### First Example Embodiment

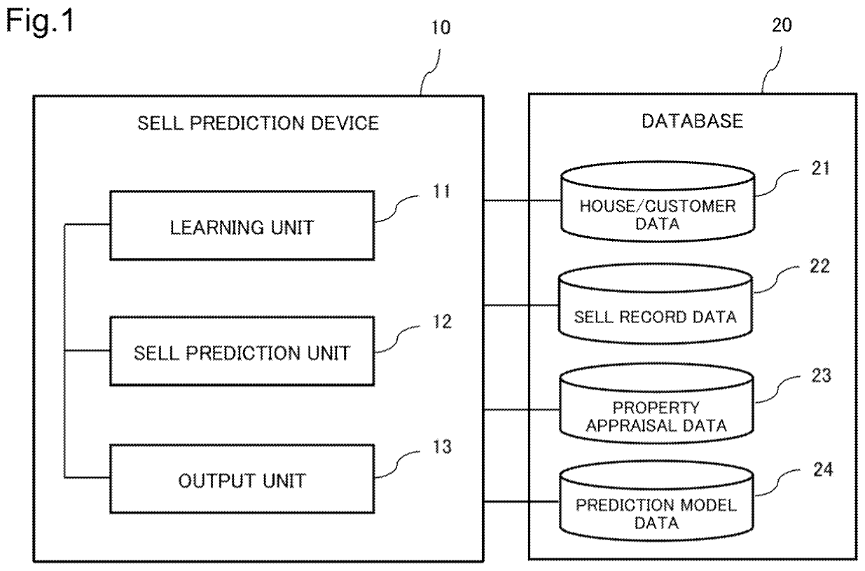

A sell prediction system according to a first example embodiment will be described with reference to the drawings. FIG. 1 is a block diagram illustrating an example of a configuration of the sell prediction system according to the first example embodiment. The sell prediction system illustrated in FIG. 1 includes a sell prediction device 10 and a database 20. An example of the sell prediction device 10 is a computer. An example of the database 20 is a memory or a storage.

The sell prediction device 10 includes a learning unit 11, a sell prediction unit 12, and an output unit 13. The database 20 stores house/customer data 21, sell record data 22, property appraisal data 23, and prediction model data 24.

### Database

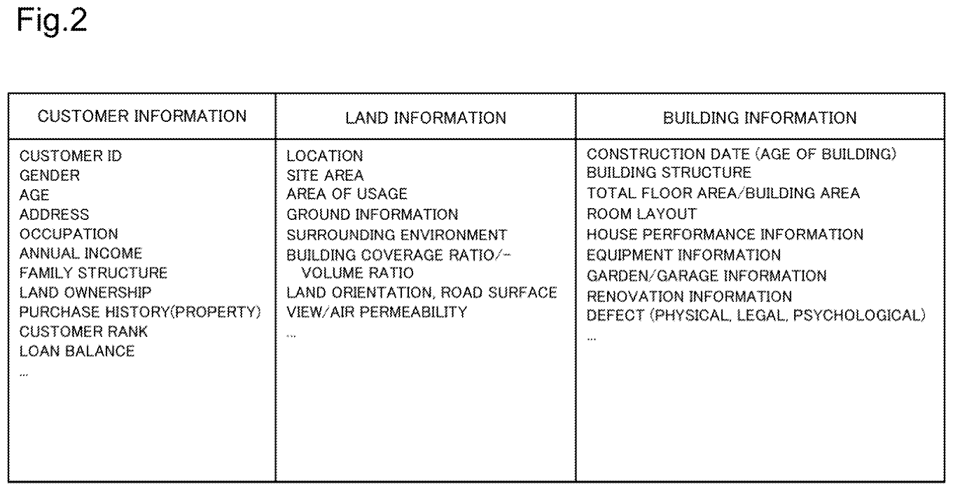

FIG. 2 is a data structure illustrating an example of the house/customer data 21. The house/customer data 21 illustrated in FIG. 2 includes customer information, land information, and building information. The house/customer data 21 is not limited to these pieces of information.

The customer information is information indicating attributes of the customers, and includes, for example, data including items such as customer IDs, gender, age, addresses, occupations, annual incomes, family structures, land ownerships, purchase histories (property), customer ranks, and loan balances. Note that the customer information is not limited to the above items, and may include other items that may have an impact on the selling behavior of the customer, such as a social network service (SNS) history.

The land information is information indicating attributes of land, and includes, for example, data including items such as locations, site area, area of usage, ground information, surrounding environment, building coverage ratio/volume ratio, land orientation, road surface, view/air permeability, and the like. The surrounding environment is information on facilities related to life around a house. The facilities represent, for example, commercial facilities, medical facilities, schools, parks, or the like. Note that the land information is not limited to the above items, and may include other items that may have an impact on the selling behavior of the customer.

The building information is information indicating attributes of buildings, and includes, for example, data including items such as construction dates (age of a building), building structures, total floor area/building area, room layouts, house performance information, equipment information, garden/garage information, renovation information, and defects (physical, legal, psychological). The equipment information includes information on electric equipment such as lighting, outlets, and intercoms, air conditioning equipment such as cooling and heating, and a ventilation fan, and water supply/discharge equipment such as a kitchen, a toilet, and a bathroom. The garden/garage information includes information on the presence or absence and size of a garden or a garage. The renovation information includes repair of interior and exterior of the building, repair of facilities such as a bath, a toilet, and a kitchen, repair costs, and repair dates. The building information is not limited to the above items, and may include other items that may have an impact on the selling behavior of the customer.

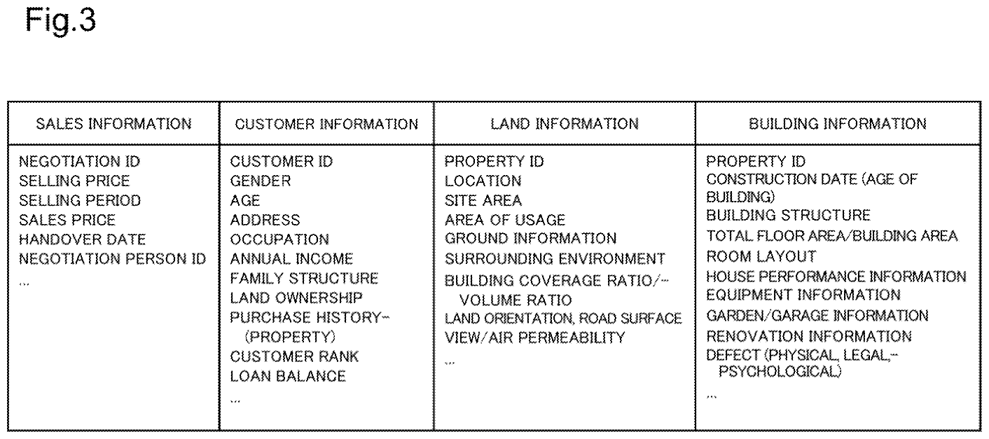

FIG. 3 is a data structure illustrating an example of the sell record data 22. The sell record data 22 illustrated in FIG. 3 includes sales information, customer information, land information, and building information. The sales information is information regarding selling of a house for which a transaction was established in the past. The sales information includes, for example, data including items such as negotiation IDs, selling prices, sales prices, selling periods, handover dates, negotiation person IDs, and the like. Note that the customer information, the land information, and the building information in the sell record data of FIG. 3 may be the data of items used for the customer information, the land information, and the building information illustrated in FIG. 2.

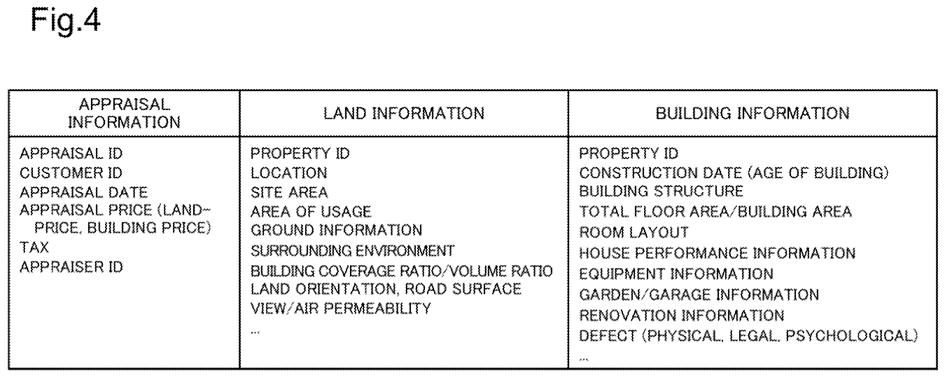

FIG. 4 is a data structure illustrating an example of the property appraisal data. The property appraisal data 23 illustrated in FIG. 4 includes appraisal information, land information, and building information. The appraisal information is information regarding appraisal of the property. The appraisal information includes data of items including appraisal IDs, customer IDs, appraisal dates, appraisal prices (land prices, building prices), taxes, appraiser IDs, and the like, for example.

The appraisal price is calculated by a transaction broker as a price at which the property is likely to be sold. For example, the appraisal price is calculated in comparison with a latest sale case of a property under conditions similar to those of the property (house) to be appraised. For this reason, the appraisal price is different for each transaction broker. A seller determines the selling price with reference to the plurality of appraisal prices. Note that the land information and the building information in the property appraisal data of FIG. 4 may be the data of items used in the land information and the building information illustrated in FIG. 2.

The prediction model data includes a plurality of prediction models generated by the learning unit 11. The prediction model is generated by a machine learning algorithm based on data related to house sales. The generated prediction model is a model that predicts customers who are likely to sell a house. Examples of the data related to house sales include the sell record data and property appraisal data.

### Sell Prediction Device

The sell prediction device according to a first example embodiment will be described with reference to the drawings. In FIG. 1, the sell prediction device 10 includes the learning unit 11, the sell prediction unit 12, and the output unit 13. The learning unit 11 acquires the house/customer data 21, the sell record data 22, and the property appraisal data 23 from the database 20. The learning unit 11 performs machine learning using the acquired house/customer data 21, sell record data 22, and property appraisal data 23, and calculates (generates) a prediction model and various parameters related to the prediction model. For example, the learning unit 11 learns using the house/customer data 21 and property appraisal data 23 having sell records as explanatory variables and a record whether the property has been sold from the sell record data 22 as an objective variable, and generates a prediction model. The learning unit 11 registers the generated prediction model and various parameters in the database 20 and updates the prediction model data 24.

For example, the learning unit 11 generates a prediction model by using heterogeneous mixed learning including FAB inference (Factorized Asymptotic Bayesian Inference) or the like. Note that a method of heterogeneous mixed learning is disclosed in, for example, PTL 2. Specifically, the learning unit 11 generates a prediction model including a plurality of prediction equations that are regression equations and selection conditions of the prediction equations. In the learning unit 11, a plurality of regularities (prediction equations) and condition data (house/customer data, sell record data, and property appraisal data) in which the regularities are held are derived from the house/customer data 21, the sell record data 22, and the property appraisal data 23 by the learning algorithm.

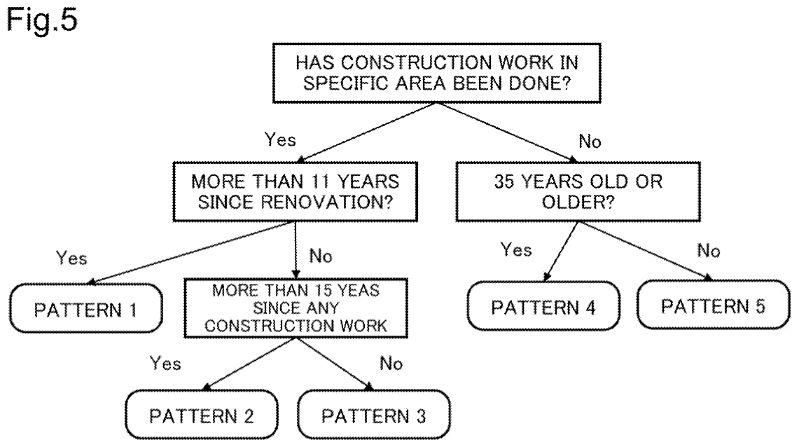

FIG. 5 is a diagram illustrating an example of the prediction model. The prediction model illustrated in FIG. 5 is expressed by a tree structure based on a plurality of classified prediction equations (patterns 1, 2, 3, 4, and 5) and selection conditions. A conditional equation is assigned to an internal node of the tree structure, and each prediction equation is assigned to a leaf node. For example, one conditional equation using a feature amount such as “Has construction work in specific area been done?” is allocated to the internal node. Note that, in the above description, an example has been described in which the learning unit 11 generates the prediction model by heterogeneous mixed learning which is one of white box type machine learning; however, the example dose not set any limitation and decision tree learning and a general linear model may be used. For example, the learning unit 11 may generate the prediction model using another white box type machine learning. Alternatively, as the prediction model generated by the learning unit 11, other known machine learning methods such as deep learning and a neural network can be used.

The sell prediction unit 12 acquires the prediction model from the prediction model data 24 of the database 20, and inputs information of the house/customer data 21 and the property appraisal data 23 of the target customer to the acquired prediction model to obtain an output value. For example, in the case of the above prediction model, the sell prediction unit 12 calculates a score by multiplying an actual value (Y years of a building age, etc.) by the degree of an impact (weight varies depending on the pattern) of each item (age of the building, etc.) according to each classified pattern (prediction equation). For example, the sell prediction unit 12 predicts customers who are likely to sell a house by using the house/customer data and property appraisal data having no sell record. Note that the customers who are likely to sell a house may be predicted using the house/customer data and property appraisal data having sell records.

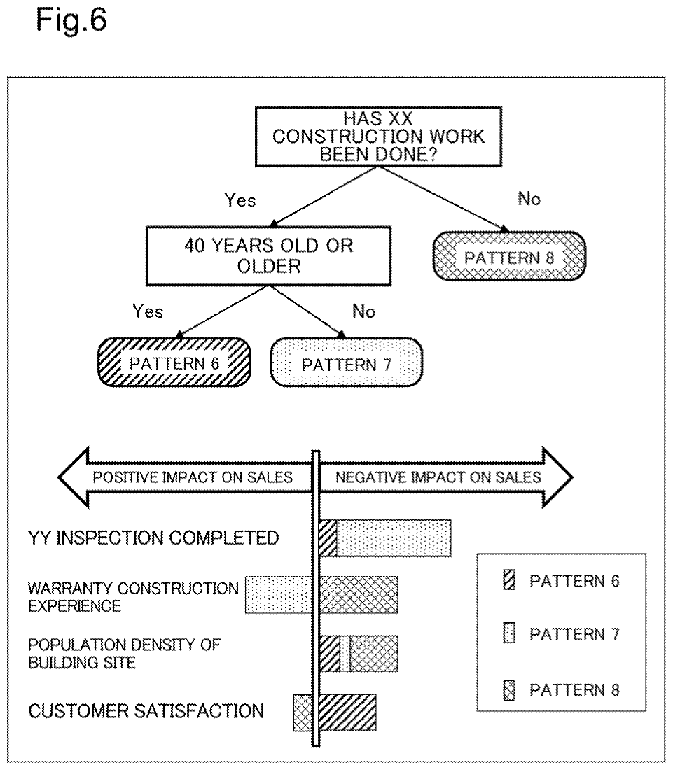

FIG. 6 is a diagram illustrating an example of the prediction model and the degrees of impacts on sale. In the prediction model illustrated in FIG. 6, the customer is classified into one of patterns 6, 7, and 8 using “implementation of XX construction work” and “age of building” (see FIG. 6). The sell prediction unit 21 calculates a score of the customer using the parameter based on the house/customer data 21 of the customer in each of the classified patterns. For example, in a case where the parameters in the classified pattern are YY inspection completed, warranty construction experience, population density of building site, and customer satisfaction, the sell prediction unit 21 calculates the values of the parameters by normalization processing (process the values so that the average is 0 and the variance is 1). The sell prediction unit 21 adds the calculated values to obtain a score of the customer. Here, the calculated value of the parameter may be weighted, and the weighted values may be added up to obtain the score of the customer. Note that the above calculation method is an example, and the score may be calculated using more parameters.

Note that data of the execution result of the sell prediction (whether the customers in the predicted customer list has actually sold property or the like) may be fed back to the prediction model.

The sell prediction unit 12 regards the customers having higher scores as customers who are more likely to sell a house, and generates a customer list by arranging the customers in descending order from a customer having a higher score. The generated customer list is sent to the output unit 13.

The sell prediction unit 12 extracts customers who are likely to sell a house based on the output value. At the time of extracting customers, it is preferable that the sell prediction unit 12 together extracts a reason why the customer is extracted, that is, a parameter that is a factor (basis of prediction) that increases the score of the customer.

As a result of the prediction by the sell prediction unit 12, the output unit 13 outputs a customer candidate that satisfies a predetermined condition in relation to the sale. The customer satisfying the predetermined condition indicates, for example, that the score calculated by the sell prediction unit 12 is a predetermined value or more.

When receiving the customer list generated by the sell prediction unit 12 in which the customer candidates are listed, the output unit 13 displays the customer list on a display unit (not illustrated) of the sell prediction device 10 or transmits the customer list to a terminal (not illustrated) of a sales representative.

The output unit 13 outputs, for example, the customer list. An example of the customer list is data including items of information on customer ranks, customer IDs, and prediction factors (calculation basis). The customer rank is a rank in which customers are ranked in descending order of scores. The sell prediction factor is a parameter having a greater impact on the calculation of the score. For example, in a case where the age of building, the renovation information, and the room layout in the building information, and the age, the family structure, and the like in the customer information are parameters having a large impact, these are output as factors of sell prediction being associated with each customer (for example, the customer IDs or the like).

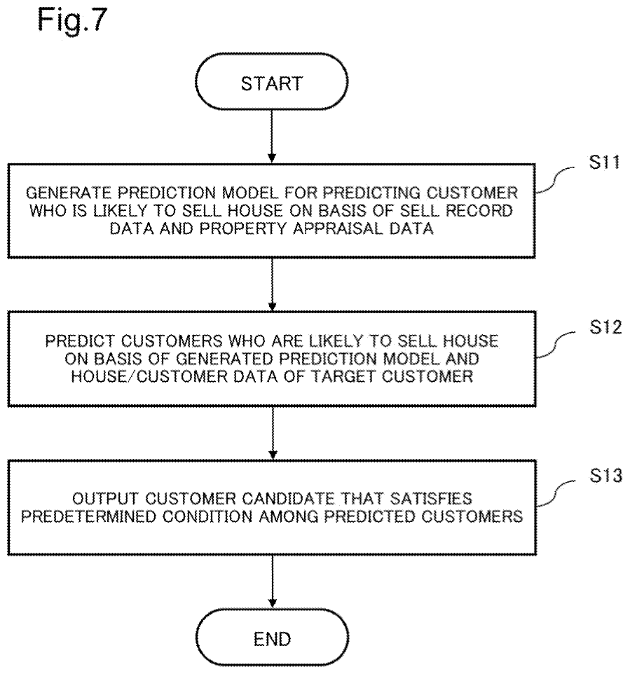

Next, the operation of the sell prediction device 10 according to the first example embodiment will be described with reference to the drawings. FIG. 7 is a flowchart illustrating an example of the operation of the sell prediction device 10. The learning unit 11 of the sell prediction device 10 acquires the house/customer data 21, the sell record data 22, and the property appraisal data 23 from the database 20. The learning unit 11 generates the prediction model for predicting customers who are likely to sell a house based on the house/customer data 21, the sell record data 22, and the property appraisal data 23 (step S11). The learning unit 11 registers the generated prediction model in the prediction model data 24 of the database 20.

The sell prediction unit 12 acquires the house/customer data 21 and the prediction model data 24 including the prediction model from the database 20. The sell prediction unit 12 predicts customers who are likely to sell a house based on the prediction model for predicting customers who are likely to sell a house and the house/customer data of the target customer (step S12). The sell prediction unit 12 sends the customers who are likely to sell a house to the output unit 13.

The output unit 13 outputs a customer candidate that satisfies a predetermined condition among the predicted customers (step S13). The output unit 13 may output a list of customer candidates as a customer list. The output unit 13 transmits, for example, the customer list to a terminal (illustrated) of the sales representative. The sales representative can improve the sales efficiency by preferentially conducting sales activities for the customers included in the customer list.

### Effects of First Example Embodiment

According to the first example embodiment, the learning unit 11 generates a prediction model for predicting customers who are likely to sell a house based on house/customer data, sell record data, and property appraisal data, and the sell prediction unit 12 predicts customers who are likely to sell a house based on the generated prediction model and house/customer data and property appraisal data of the target customers. The output unit 13 outputs the customer candidate that satisfies a predetermined condition among the predicted customers. As a result, it is possible to predict customers who are likely to sell a house.

### Second Example Embodiment

A second example embodiment of the present disclosure will be described with reference to the drawings. A sell prediction device 30 according to the second example embodiment has a configuration excluding the learning unit 11 in the sell prediction device 10 according to the first example embodiment. The sell prediction device 30 according to the second example embodiment uses the prediction model data 24 stored in the database 20 according to the first example embodiment. The prediction model data 24 includes a prediction model and the like generated by the learning unit 11 according to the first example embodiment.

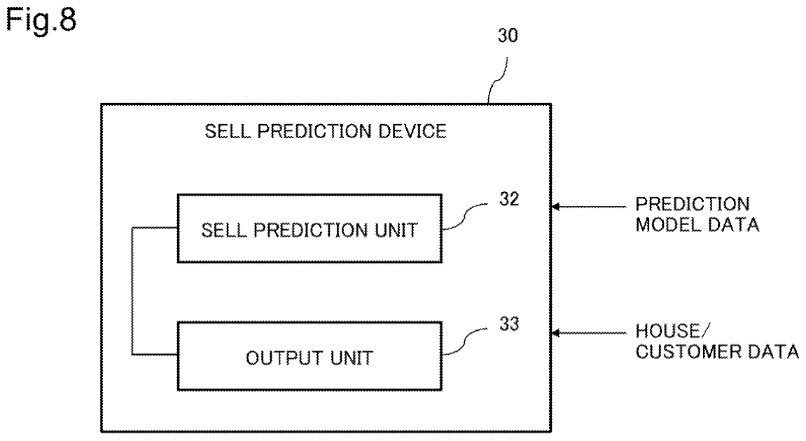

FIG. 8 is a block diagram illustrating an example of a configuration of the sell prediction device according to the second example embodiment. The sell prediction device 30 illustrated in FIG. 8 includes a sell prediction unit 32 and an output unit 33. The sell prediction unit 32 and the output unit 33 have functions similar to those of the sell prediction unit 12 and the output unit 13 according to the first example embodiment.

The sell prediction unit 32 predicts customers who are likely to sell a house in accordance with the prediction model that is generated based on house/customer data, sell record data, and property appraisal data and predicts customers who are likely to sell a house, and the house/customer data and property appraisal data of the target customer. Here, as the sell record data, the property appraisal data, and the house/customer data, data similar to the sell record data 22, the property appraisal data 23, and the house/customer data 21 described in the first example embodiment is used.

The output unit 33 outputs the customers predicted to sell a house. In the sell prediction device 10 according to the first example embodiment, the output unit 13 outputs a customer candidate satisfying a predetermined condition from predicted customers. The output unit 33 of the sell prediction device 30 according to the second example embodiment excludes a constraint due to a predetermined condition in the output unit 13.

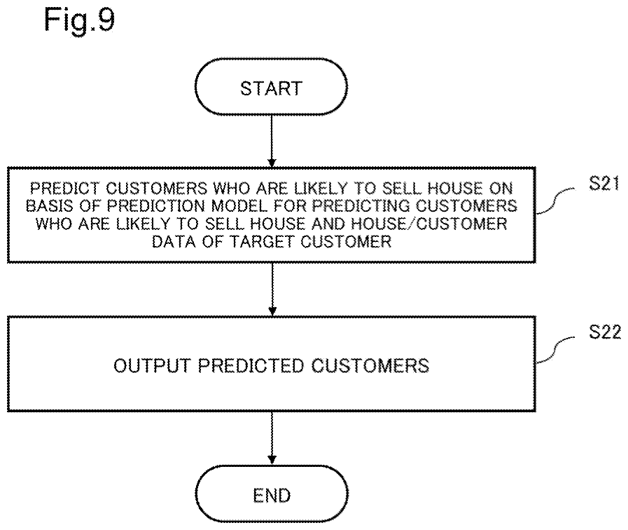

FIG. 9 is a flowchart illustrating an example of the operation of the sell prediction device 30 according to the second example embodiment. As illustrated in FIG. 9, according to the sell prediction device 30 of the second example embodiment, the sell prediction unit 32 acquires the prediction model data 24, the house/customer data 21, and the property appraisal data 23 from the database 20. The prediction model data 24 includes a prediction model that is generated based on the house/customer data 21, sell record data 22, and property appraisal data 23, and predicts customers who are likely to sell a house. The sell prediction unit 32 predicts customers who are likely to sell a house based on the house/residence data 21, the property appraisal data 23, and the prediction model (step S22). The output unit 33 outputs the predicted customers (step S22).

As in the sell prediction device 10 according to the first example embodiment, the sell prediction device 30 according to the second example embodiment can predict customers who are likely to sell a house.

### Hardware Configuration

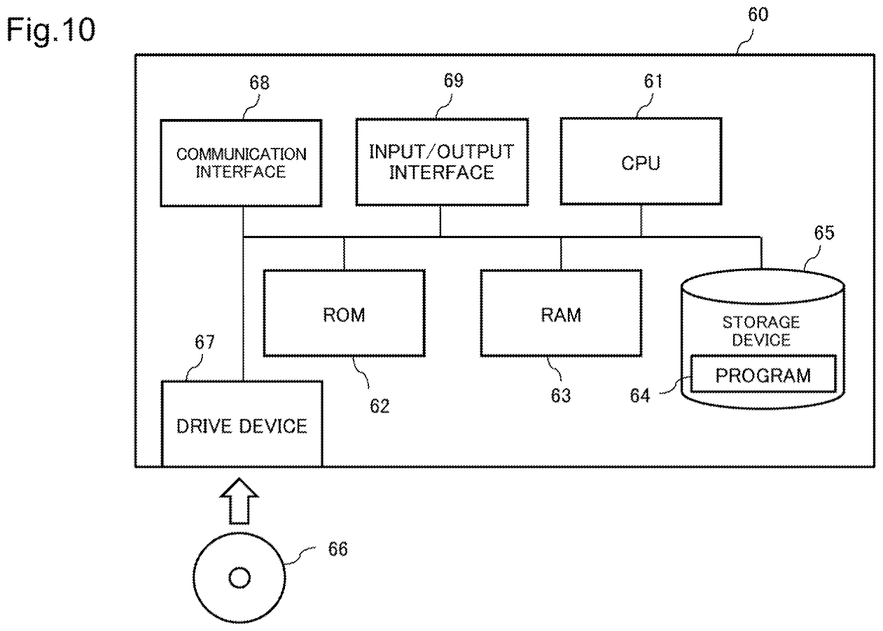

In each example embodiment, some or all of the components in the sell prediction device illustrated in FIGS. 1 and 8 can be achieved by using, for example, an arbitrary combination of a computer 60 and a program illustrated in FIG. 10. The computer 60 includes the following configuration as an example.
a CPU 61
a ROM 62
a RAM 63
a storage device 65 storing a program 64 and other data
a drive device 67 that reads and writes in a recording medium 66
a communication interface 68
an input/output interface 69 for inputting/outputting data

Each component of the sell prediction device in each example embodiment of the present application is achieved by the CPU 61 acquiring and executing the program 64 for enabling these functions. The program 64 that implements the function of each component of the sell prediction device is stored in advance in the storage device 65 or the RAM 63, for example, and is read by the CPU 61 as necessary. Note that the program 64 may be supplied to the CPU 61 via the communication network, or may be stored in advance in the recording medium 66, and the drive device 67 may read the program and supply the program to the CPU 61.

There are various modifications of the implementation method of each device. For example, the sell prediction device may be achieved by an arbitrary combination of a separate information processing device and program for each component. In addition, a plurality of components included in the sell prediction device may be achieved by an arbitrary combination of the single computer 60 and a program.

In addition, some or all of the components of the sell prediction device are achieved by other general-purpose or dedicated circuits, processors, or the like, or a combination of those devices. These may be configured by a single chip or may be configured by a plurality of chips connected via a bus.

Some or all of the components of the sell prediction device may be achieved by a combination of the above-described circuit and the like and a program.

In a case where some or all of the components of the sell prediction device are achieved by a plurality of information processing devices, circuits, and the like, the plurality of information processing devices, circuits, and the like may be arranged in a centralized manner or in a distributed manner. For example, the information processing device, the circuit, and the like may be achieved in a manner of being connected to one another via a communication network, such as a client and server system or a cloud computing system.

While the invention has been particularly illustrated and described with reference to exemplary embodiments thereof, the invention is not limited to these example embodiments. It will be understood by those of ordinary skill in the art that various changes in form and details may be made therein without departing from the spirit and scope of the present invention as defined by the claims.

### REFERENCE SIGNS LIST

10 sell prediction device
11 learning unit
12 sell prediction unit
13 output unit
20 database
21 house/customer data
22 sell record data
23 property appraisal data
24 prediction model data
30 sell prediction device
32 sell prediction unit
33 output unit
60 computer

What is claimed is:

1. A sell prediction device comprising:
one or more memories storing instructions; and
one or more processors configured to execute the instructions to:
predict customers who are likely to sell a house in accordance with a prediction model that is generated based on house/customer data, sell record data, and property appraisal data and predicts customers who are likely to sell a house, and the house/customer data and property appraisal data of target customers; and
output predicted customers.

2. The sell prediction device according to claim 1, wherein the one or more processors configured to execute the instructions to:
generate the prediction model.

3. The sell prediction device according to claim 2, wherein
the prediction model generated is composed of a plurality of prediction equations and a selection conditions of the prediction equations.

4. The sell prediction device according to claim 3, wherein the one or more processors configured to execute the instructions to:
generate the prediction model by setting the house/customer data, the sell record data, or the property appraisal data as condition data and deriving the prediction equation and the condition data that satisfies the prediction equation from candidates of the prediction model.

5. The sell prediction device according to claim 4, wherein the one or more processors configured to execute the instructions to:
extract, as a prediction factor, an item that has an impact on a prediction in the prediction model used for the predicted customers.

6. The sell prediction device according to claim 4, wherein the one or more processors configured to execute the instructions to:
extract, as a prediction factor, an item having an influence rate that satisfies a predetermined condition in the prediction model used for the predicted customers.

7. The sell prediction device according to claim 5, wherein the one or more processors configured to execute the instructions to:
output a customer list including the predicted customers and the prediction factor related to the predicted customers.

8. The sell prediction device according to claim 1, wherein
output a customer candidate that satisfies a predetermined condition from the predicted customers.

9. A sell prediction method comprising:
predicting customers who are likely to sell a house in accordance with a prediction model that is generated based on house/customer data, sell record data, and property appraisal data and predicts customers who are likely to sell a house, and the house/customer data and property appraisal data of target customers; and
outputting predicted customers.

10. A recording medium storing a sell prediction program that causes a computer to execute processing comprising:
predicting customers who are likely to sell a house in accordance with a prediction model that is generated based on house/customer data, sell record data, and property appraisal data and predicts customers who are likely to sell a house, and the house/customer data and property appraisal data of target customers; and
outputting predicted customers.
